(19) United States
(12) Patent Application Publication
(10) Pub. No.: US 2026/0361166 A1
(43) Pub. Date: Nov. 12, 2026

(54) Electric Motor and Pump Assembly and Turbine and Electric Generator Assembly

(71) Applicant: Elliott Company, Jeannette, PA (US)

(72) Inventors: Enver Sinan Karakas, Reno, NV (US); August Bracewell Brautigam, Reno, NV (US)

(21) Appl. No.: 19/573,082

(22) Filed: Mar. 20, 2026

Related U.S. Application Data
(60) Provisional application No. 63/800,623, filed on May 6, 2025.

(51) Int. Cl. H02K 3/02; H02K 5/132; H02K 5/20; H02K 7/08; H02K 7/18

(52) U.S. Cl. CPC H02K 3/02; H02K 5/132; H02K 5/203; H02K 7/083; H02K 7/1823

(57) ABSTRACT

An electric motor and pump assembly is configured to be submerged in liquid ammonia. The motor and pump assembly includes a shaft configured to rotate around an axis. The motor and pump assembly includes a pump having at least one impeller and a liquid flow path having an inlet and an outlet. The at least one impeller is fixed to the shaft and is configured to rotate around the axis together with the shaft. The motor and pump assembly includes a motor having a rotor fixed to the shaft and a stator surrounding the rotor. The rotor is configured to rotate around the axis together with the shaft. The stator includes conductive windings. The conductive windings include a conductor. The conductor includes aluminum.

### CROSS REFERENCE TO RELATED APPLICATIONS

The present application claims priority to United States Provisional Application Serial No. 63/800,623, entitled “Submerged Ammonia Pump and Turbine Generator with Aluminum Windings”, filed May 6, 2025, which is incorporated herein by reference in its entirety.

### BACKGROUND

### Field

The present disclosure is directed to an electric motor and pump assembly and a turbine and electric generator assembly. More specifically, the present disclosure is directed to an electric motor and pump assembly and a turbine and electric generator assembly each configured to be submerged in a liquified gas, such as liquid ammonia.

### Description of Background Art

Liquid ammonia (NH₃) is commonly utilized in various chemical and petrochemical processes. Liquid ammonia as a liquified gas is normally stored in bulk at atmospheric pressure and a temperature of approximately –33 ºC or less. Liquid ammonia is highly caustic, which presents a harsh environment to surrounding materials. Transferring liquid ammonia using rotating equipment presents challenges for such equipment to operate safely and reliably in a harsh environment. Liquid ammonia is also corrosive to copper, copper alloys, and other materials, which requires different material selection from conventional pump or turbine designs.

Magnetic couplings currently used for smaller ammonia pump/motor or turbine/generator applications do not meet the torque and pressure conditions and magnitudes for ammonia pumps/motors and turbines/generators that are requested in the industry and/or marketplace. The reasonable pressure and torque limits for magnetic couplings is 94 bar and 2726 N-m. The pressure barrier between, for example, a motor side of the coupling and a pump side of the coupling is too thick to allow the transmission of large amounts of torque, because the pressure barrier resides in the air gap between the coupling’s motor magnets and the coupling’s pump magnets. A thicker pressure barrier permits less torque transmission, as the force between a set of magnets is inversely proportional to the distance between them squared. Similarly, an ammonia turbine with an operating pressure of 180 bar and a rated torque of 2158 N-m cannot be designed using a magnetic coupling, as a magnetic coupling cannot be sourced that will handle this pressure.

Ammonia is incompatible with copper windings that are used in typical cryogenic motors or generators. Therefore, in prior ammonia cryogenic motor or generator applications, the motor or generator is placed in a nitrogen-purged can and torque is transmitted from the purged motor can to the pump section or from the turbine section to the generator can through the use of a magnetic coupling. That is, in prior ammonia motor or generator applications, the pump and motor or the turbine and generator are on separate shafts, thus, relying on the use of a magnetic coupling. However, as identified above, the magnetic couplings that are currently offered do not meet the torque and pressure conditions and magnitudes for ammonia pumps and turbines that are requested in the industry and/or marketplace.

Therefore, there remains a need for an electric motor and pump assembly and a turbine and electric generator assembly that can be submerged in a liquified gas, such as liquid ammonia, and that can satisfy the torque and pressure conditions and magnitudes requested in the industry and/or marketplace

### SUMMARY

In some non-limiting embodiments or aspects of the present disclosure, an electric motor and pump assembly is configured to be submerged in a liquified gas. The motor and pump assembly includes a shaft configured to rotate around an axis. The motor and pump assembly includes a pump having at least one impeller and a liquid flow path having an inlet and an outlet. At least one impeller is fixed to the shaft and is configured to rotate around the axis together with the shaft. The motor and pump assembly includes a motor having a rotor fixed to the shaft and a stator surrounding the rotor. The rotor is configured to rotate around the axis together with the shaft. The stator includes conductive windings. The conductive windings are configured to receive an electric current thereby causing the rotor, the shaft, and the at least one impeller to rotate and produce a pressurized flow of the liquid through at least a portion of the liquid flow path and the liquid outlet. The conductive windings include a conductor. The conductor includes aluminum.

One or more of the following features can be included in the non-limiting embodiments or aspects of the electric motor and pump assembly.

The liquified gas can be ammonia.

The shaft can be a single shaft.

The conductive windings can be submerged in the liquid flow path of the liquified gas thereby cooling the conductive windings during operation.

The motor can include bearings surrounding the shaft. The bearings can be submerged in the liquid flow path of the liquified gas thereby cooling and lubricating the bearings during operation.

The conductive windings can include a coating surrounding the conductor.

The conductor can have an aluminum content of at least 95% by weight.

The conductor can consist entirely of aluminum.

The pump is configured to discharge the liquid from the liquid outlet at a flow rate of at least approximately 900 m³/hour and at most approximately 2,500 m³/hour.

The motor can have a rated power range of approximately 188 kW to approximately 1,160 kW.

Each of the conductive windings can have a voltage rating of approximately 4,160 V.

The motor can have a rated torque range of approximately 997 N-m to approximately 7,388 N-m.

The motor can have a rated synchronous speed of 1,500 RPM or 1,800 RPM. A broader speed range can be achieved through the use of a Variable Frequency Drive (VFD).

In some non-limiting embodiments or aspects of the present disclosure, a turbine and electric generator assembly is configured to be submerged in a liquified gas. The turbine and generator assembly includes a shaft configured to rotate around an axis. The turbine and generator assembly includes a turbine having at least one turbine runner and a liquid flow path having an inlet and an outlet. At least one turbine runner is fixed to the shaft and is configured to rotate around the axis together with the shaft. The turbine and generator assembly includes a generator having a rotor fixed to the shaft and a stator surrounding the rotor. The rotor is configured to rotate around the axis together with the shaft. The stator includes conductive windings. The liquid inlet of the turbine is configured to receive a pressurized flow of the liquid thereby causing at least one runner, the shaft, and the rotor to rotate and produce an electric current through the conductive windings. The conductive windings include a conductor. The conductor includes aluminum.

One or more of the following features can be included in the non-limiting embodiments or aspects of the turbine and electric generator assembly.

The liquified gas can be ammonia.

The shaft can be a single shaft.

The conductive windings can be submerged in the liquid flow path of the liquified gas thereby cooling the conductive windings during operation.

The generator further includes bearings surrounding the shaft. The bearings can be submerged in the liquid flow path of the liquified gas thereby cooling and lubricating the bearings during operation.

The conductive windings can include a coating surrounding the conductor.

The conductor can have an aluminum content of at least 95% by weight.

The conductor of the conductive windings can consist entirely of aluminum.

The turbine is configured to withstand a head of the liquid of at least approximately 400 meters and at most approximately 1600 meters.

The generator can have a rated power range of approximately 167 kW to approximately 2,674 kW.

Each of the conductive windings can have a voltage rating of approximately 4,160 V.

The generator can have a rated torque range of approximately 443 N-m to approximately 8,511 N-m.

The generator can have a rated synchronous speed of 3,000 RPM or 3,600 RPM. A broader speed range can be achieved through the use of a VFD.

### BRIEF DESCRIPTION OF THE DRAWINGS

FIG. 1 is a cross-sectional view of an electric motor and pump assembly, according to some non-limiting embodiments or aspects of the present disclosure;

FIG. 2 is a cross-sectional view of a turbine and electric generator assembly, according to some non-limiting embodiments or aspects of the present disclosure;

FIG. 3 is an expanded, partial, and cutaway view of a conductive winding, according to some non-limiting embodiments or aspects of the present disclosure;

FIG. 4 is a cross-sectional view of the electric motor and pump assembly of FIG. 1 displaying at least a portion of a liquid flow path therethrough, according to some non-limiting embodiments or aspects of the present disclosure; and

FIG. 5 is a cross-sectional view of the turbine and electric generator assembly of FIG. 2 displaying at least a portion of a liquid flow path therethrough, according to some non-limiting embodiments or aspects of the present disclosure.

### DETAILED DESCRIPTION

As used herein, the singular form of “a”, “an”, and “the” include plural referents unless the context clearly dictates otherwise.

Spatial or directional terms, such as “left”, “right”, “inner”, “outer”, “above”, “below”, “lower”, “central”, “upper”, and the like, relate to the embodiments or aspects as shown in the drawing figures and are not to be considered as limiting as the embodiments or aspects can assume various alternative orientations.

All numbers used in the specification and claims are to be understood as being modified in all instances by the term “about”. By “about” is meant within plus or minus twenty-five percent of the stated value. However, this should not be considered as limiting to any analysis of the values under the doctrine of equivalents.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less. The ranges and/or ratios disclosed herein represent the average values over the specified range and/or ratio.

The terms “first”, “second”, and the like are not intended to refer to any particular order or chronology, but refer to different conditions, properties, or elements.

All documents referred to herein are “incorporated by reference” in their entirety.

The term “at least” is synonymous with “greater than or equal to”.

As used herein, “at least one of” is synonymous with “one or more of”. For example, the phrase “at least one of A, B, or C” means any one of A, B, or C, or any combination of any two or more of A, B, or C. For example, “at least one of A, B, and C” includes A alone; or B alone; or C alone; or A and B; or A and C; or B and C; or all of A, B, and C.

The word “comprising” and “comprises”, and the like, does not exclude the presence of elements or steps other than those listed in any claim or the specification as a whole. In the present specification, “comprises” means “includes” and “comprising” means “including”.

As used herein, the terms “parallel” or “substantially parallel” mean a relative angle as between two objects (if extended to theoretical intersection), such as elongated objects and including reference lines, that is from 0° to 5°, or from 0° to 3°, or from 0° to 2°, or from 0° to 1°, or from 0° to 0.5°, or from 0° to 0.25°, or from 0° to 0.1°, inclusive of the recited values.

As used herein, the terms “perpendicular”, “transverse”, “substantially perpendicular”, or “substantially transverse” mean a relative angle as between two objects at their real or theoretical intersection is from 85° to 90°, or from 87° to 90°, or from 88° to 90°, or from 89° to 90°, or from 89.5° to 90°, or from 89.75° to 90°, or from 89.9° to 90°, inclusive of the recited values.

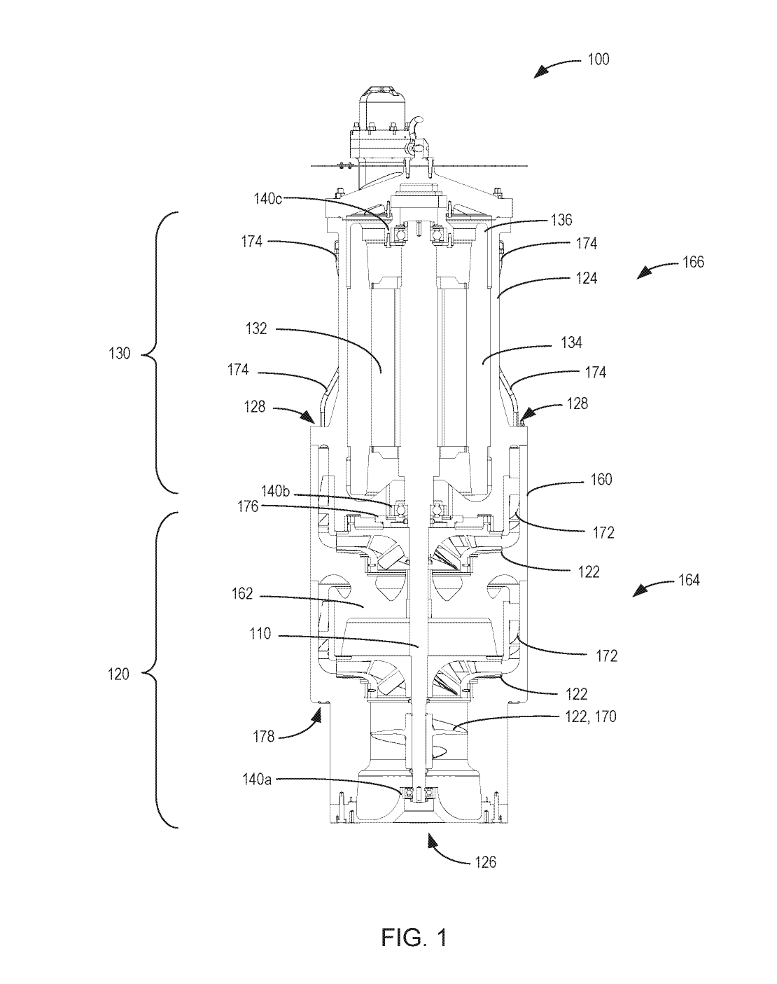

FIG. 1 is a cross-sectional view of an electric motor and pump assembly 100, according to some non-limiting embodiments or aspects of the present disclosure. The electric motor and pump assembly 100 is configured to be submerged in a liquified gas. The liquified gas can have a very low temperature. The liquified gas can be liquid ammonia. Ammonia has a boiling point of approximately –33.34 ºC or –28.01 °F at atmospheric pressure. As identified above, liquid ammonia as a liquified gas can be stored at atmospheric pressure and a temperature of approximately –33 ºC or less.

With reference to FIG. 1, the electric motor and pump assembly 100 includes a shaft 110 configured to rotate around an axis. The axis (not shown) can be a central axis of the shaft 110. The shaft 110 can be a single shaft. That is, the electric motor and pump assembly 100 can have only one shaft 110. Furthermore, the shaft 110 can have a composition that is made of only one material. Therefore, the shaft 110 can be a single, monolithic shaft. The shaft 110 can be made of stainless steel, such as austenitic, ferritic, or martensitic stainless steel. In a preferred embodiment, the shaft 110 is made of 15-5 PH stainless steel. As will be discussed below, the impeller 122 of the pump 120 and the rotor 132 of the motor 130 can each be fixed to this single shaft 110. Therefore, the shaft 110 can also be a common shaft shared by each of the impeller 122 of the pump 120 and the rotor 132 of the motor 130. The impeller 122 of the pump 120 and the rotor 132 of the motor 130 can each be fixed to the shaft 110 by any mechanism known in the art. Fixing the impeller 122 of the pump 120 and the rotor 132 of the motor 130 to a single, common shaft simplifies the design, increases the stiffness of the assembly, and eliminates a shaft coupling and a nitrogen-purged space from the assembly.

The electric motor and pump assembly 100 includes a pump 120. The pump 120 includes at least one impeller 122 and a liquid flow path 124, including an inlet 126 and an outlet 128. In one embodiment, as shown in FIG. 1, the pump 120 includes multiple impellers 122. However, in another embodiment, the pump 120 can include only one impeller 122. The at least one impeller 122 is fixed to the shaft 110 and is configured to rotate around the axis together with the shaft 110. Each impeller 122 can include a body having a hub and vanes or blades. Each impeller 122 can be fixed to the shaft 110 at the hub. The vanes or blades can pull and/or push the liquid through the liquid flow path 124 of the electric motor and pump assembly 100. The impeller 122 can be made of aluminum or stainless steel. In a preferred embodiment, the impeller 122 is made of cast aluminum. Operation of the pump 120 will be discussed below.

The electric motor and pump assembly 100 includes a motor 130. The motor 130 includes a rotor 132 fixed to the shaft 110 and a stator 134 surrounding the rotor 132. The rotor 132 is configured to rotate around the axis together with the shaft 110. The motor 130 can have a rated power range of approximately 188 kW to approximately 1,160 kW. The rated power is the upper limit of power output that the motor 130 can continuously maintain without damage or failure to the motor 130. The motor 130 can have a rated torque range of approximately 997 N-m to approximately 7,388 N-m. The rated torque is the upper limit of torque that the motor 130 can continuously produce or withstand at its rated power. The motor 130 can have a rated synchronous speed of 1,500 RPM or 1,800 RPM. A broader speed range can be achieved through the use of a Variable Frequency Drive (VFD).

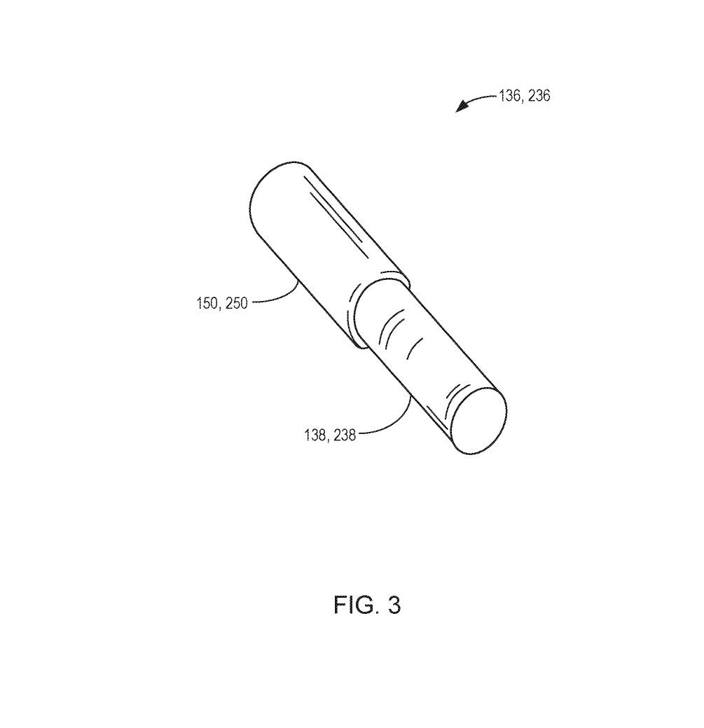

FIG. 3 is an expanded, partial, and cutaway view of a conductive winding 136, according to some non-limiting embodiments or aspects of the present disclosure. The stator 134 can include a stator core having slots and conductive windings 136 positioned in the slots such that the conductive windings 136 circumferentially surround the rotor 132. With reference to FIG. 3, the conductive windings 136 include a conductor 138. The conductor 138 includes aluminum. In one embodiment, the conductor 138 includes an aluminum content of at least 95% by weight. In another embodiment, the conductor 138 consists entirely of aluminum. In one embodiment, the conductor 138 is an aluminum alloy.

The conductive windings 136 can include a coating 150 surrounding the conductor 138. With reference to FIG. 3, at least a portion of the coating 150 is cut away to reveal the conductor 138. In one embodiment, the coating 150 can surround the entire outer surface of the conductor 138. However, in another embodiment, the coating 150 partially surrounds the outer surface of the conductor 138. The coating 150 can be made of an aromatic polyamide (aramid) or a polyaryletherketone (PAEK). In a preferred embodiment, the coating 150 is made of aramid paper or fibers. In another preferred embodiment, the coating 150 is made of polyether ether ketone (PEEK). As will be discussed below, the conductive windings 136 are submerged in the liquid flow path 124 of the liquified gas thereby cooling the conductive windings 136 during operation.

Each of the conductive windings 136 can have a voltage rating of approximately 4,160 V. With developments, it is anticipated that each of the conductive windings 136 can have a voltage rating of approximately 6,600 V. Aluminum is approximately 1.6 times as resistive as copper. Therefore, conductive windings 136 having both an aluminum composition and a voltage rating of approximately 6,600 V are not readily available. The voltage rating is the upper limit of voltage that the conductive windings 136 can continuously handle without damage, failure, and/or dielectric breakdown to the conductive windings 136.

The rotor 132 can include a stack of silicon iron laminations held together by aluminum rotor bars and aluminum end caps.

The electric motor and pump assembly 100 can include a housing 160 and an interior 162. Each of the pump 120 and the motor 130 can be positioned inside the housing 160 within the interior 162. That is, because the electric motor and pump assembly 100 can have only one shaft 110 and because the impeller 122 of the pump 120 and the rotor 132 of the motor 130 can each be fixed to this single shaft 110, two separate housings for each of the pump 120 and the motor 130 are not required. Therefore, the electric motor and pump assembly 100 can have only one housing 160, in which the interior 162 is defined by the housing 160 within both the pump 120 and the motor 130. Nonetheless, while the electric motor and pump assembly 100 does not include a pump housing and a separate motor housing, for the understanding of the present disclosure, the housing 160 can be considered to include a pump side 164 and a motor side 166.

Each of the rotor 132 and the stator 134 can be positioned inside the housing 160 within the interior 162 at the motor side 166. At the motor side 166, the housing 160 can include an interior sidewall circumferentially or annularly surrounding the motor 130. The stator 134 can be fixed to at least a portion of the interior sidewall of the housing and can annularly or circumferentially surround the rotor 132.

While the electric motor and pump assembly 100 can have only one housing 160, the housing 160 may be formed by a plurality of housing components. The housing 160 can be made of aluminum or stainless steel. In a preferred embodiment, the housing 160 is made of aluminum.

The electric motor and pump assembly 100 can include bearings 140a-c surrounding the shaft 110. For example, the motor side 166 can include bearings 140b, 140c surrounding the shaft 110 and the pump side 164 can include bearing 140a surrounding the shaft 110. The bearings 140a-c support the rotation of the shaft 110 and reduce friction thereof during operation of the electric motor and pump assembly 100. As shown in FIG. 1, the motor 130 can include multiple bearings 140a-c each positioned in proximity to different portions of the shaft 110. For example, an upper bearing 140c can be positioned in proximity to an upper portion the shaft 110, a central bearing 140b can be positioned in proximity to a central portion of the shaft 110, and/or a lower bearing 140a can be positioned in proximity to a lower portion of the shaft 110. As will be discussed below, the bearings 140a-c are submerged in the liquid flow path 124 of the liquified gas thereby cooling and lubricating the bearings 140a-c during operation of the electric motor and pump assembly 100. The bearings 140a-c can be made of steel or stainless steel with silicon nitride balls, such as 440C stainless steel or SAE 52100 steel with silicon nitride balls. In a preferred embodiment, the bearings 140a-c are made of SAE 52100 steel with silicon nitride balls.

One of the impellers 122 can be an inducer 170. The inducer 170 is fixed to the shaft 110 and is configured to rotate around the axis together with the shaft 110. The inducer 170 can be helical. The inducer 170 is positioned in proximity to the inlet 126 of the pump 120 at the pump side 164 of the electric motor and pump assembly 100. The inducer 170 can be an axial flow impeller fixed to a lower portion of the shaft 110 to induce or improve suction. The inducer 170 can be made of aluminum or stainless steel. In a preferred embodiment, the inducer 170 is made of aluminum.

Operation of the electric motor and pump assembly 100 is as follows. The conductive windings 136 of the stator 134 receive an alternating current from a power supply (not shown). The alternating current flowing through the conductive windings 136 of the stator 134 induces a rotating magnetic field. The rotating magnetic field of the stator 134 induces a current in the rotor 132. The induced current in the rotor 132 generates a magnetic field in turn, and the magnetic field of the rotor 132 lags the magnetic field of the stator 134. This lag is known as “positive slip.” A tangential force is generated between the magnetic field of the stator 134 and the magnetic field of the rotor 132, and this tangential force generates a torque about the central axis of the rotor 132 that causes the rotor 132 to rotate. The rotation of the rotor 132 thereby causes the shaft 110 and each impeller 122 (as well as any other components fixed to the shaft 110, such as the inducer 170) to rotate and produce a pressurized flow of the liquid through at least a portion of the liquid flow path 124 and the liquid outlet 128. That is, the electric motor and pump assembly 100 ultimately converts electrical current from the conductive windings 136 of the stator 134 of the motor 130 into mechanical torque that is used to drive each impeller 122 of the pump 120.

More specifically, when the motor 130 receives power, the rotor 132, the shaft 110, each impeller 122, and the inducer 170 rotate, and the liquified gas flows into the inlet 126 of the pump 120 and into each impeller 122. The liquified gas is pressurized as each impeller 122 rotates, and the liquified gas flows through at least a portion of the liquid flow path 124 and the outlet 128. Because the electric motor and pump assembly 100 does not require a magnetic coupling nor pressure barrier between the pump 120 and the motor 130, the electric motor and pump assembly 100 can produce and apply a greater torque with the rotor 132, the shaft 110, and each impeller 122 than pumps/motors that rely on magnetic couplings for transmission of torque. The greater torque generation by the electric motor and pump assembly 100 allows the electric motor and pump assembly 100 to produce greater flow rates than pumps/motors that rely on magnetic couplings for transmission of torque. Therefore, the electric motor and pump assembly 100 can produce a flow rate of the liquid at the liquid outlet 128 of at least approximately 900 m³/hour and at most approximately 2,500 m³/hour. The electric motor and pump assembly 100 can produce a head of at least approximately 90 meters and at most approximately 200 meters. The pump 120 is configured to discharge the liquid from the liquid outlet 128 at a pressure of at least 20 bar. The electric motor and pump assembly 100 can have an efficiency of 80%.

A portion of the liquid flow path 124 includes the cavities, gaps, or hollow spaces within the motor 130. That is, the liquified gas flows through the hollow spaces surrounding the rotor 132, stator 134, conductive windings 136, and bearings 140a-c. Therefore, the conductive windings 136 are submerged in the liquid flow path 124 of the liquified gas thereby cooling the conductive windings 136 during operation of the electric motor and pump assembly 100. That is, heat or energy that is generated in the conductive windings 136 during operation of the electric motor and pump assembly 100 is transferred to the liquified gas. Furthermore, the bearings 140a-c are submerged in the liquid flow path 124 of the liquified gas thereby cooling and lubricating the bearings 140a-c during operation of the electric motor and pump assembly 100. That is, heat or energy that is generated in the bearings 140a-c during operation of the electric motor and pump assembly 100 is transferred to the liquified gas, and friction that is generated by the movement of the components of the bearings 140a-c is minimized by contact with the liquified gas.

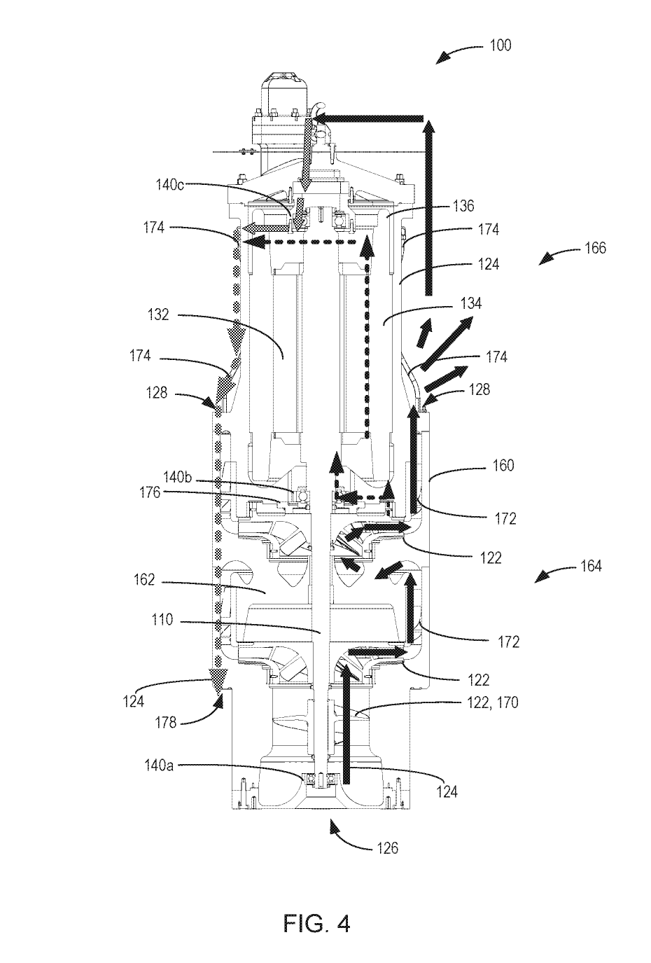

With reference to FIG. 4, flow of the liquified gas through the liquid flow path 124 in the electric motor and pump assembly 100 is as follows. As shown by the solid black arrows in FIG. 4, the liquified gas enters inlet 126 and the inducer 170 which supplies adequate net positive suction head (NPSH) to at least the initial impeller 122 to prevent cavitation. Each impeller 122 generates pressure and increases the velocity of the liquified gas by accelerating it centrifugally. Velocity is recovered from the liquefied gas and is converted into increased pressure of the liquified gas by each diffuser 172. At least a portion of the liquified gas exits the outlet 128 and enters the liquified gas column (not shown) at the discharge (higher) pressure.

As shown by the gray arrows, a portion of the liquified gas discharged from the outlet 128 and into the column is diverted from the column and enters the upper bearing 140c, which lubricates and cools the upper bearing 140c, through a lubrication orifice (not shown). This upper bearing 140c lubrication flow (gray arrows) of the liquid flow path 124 passes through the return lines 174 and is returned to the inlet 126 side of the pump 120.

As shown by the arrows composed of black dashes, a portion of the liquified gas flowing through the impellers 122 and diffusers 172 is diverted through a thrust equalizing mechanism (TEM®) 176 and the central bearing 140b, which cools and lubricates the central bearing 140b. This portion of the liquified gas passes through the gap between the rotor 132 and the stator 134, which cools the conductive windings 136. Furthermore, this portion of the liquified gas joins the bearing lubrication flow (gray arrows combined with dashes) and returns to the inlet 126 side of the pump 120 through the return lines 174. As shown in FIG. 1, the electric motor and pump assembly 100 includes an O-ring 178 that seals the lower pressure inlet 126 side from the higher pressure side in the column (not shown). The thrust equalizing mechanism 176 is described in U.S. Patent No. 9,341,191 B2, the disclosure of which is incorporated herein by reference in its entirety. The thrust equalizing mechanism 176 removes thrust loads on the bearings 140a-c in the electric motor and pump assembly 100 and allows for cooling of the conductive windings 136 and cooling and lubrication of the central bearing 140b.

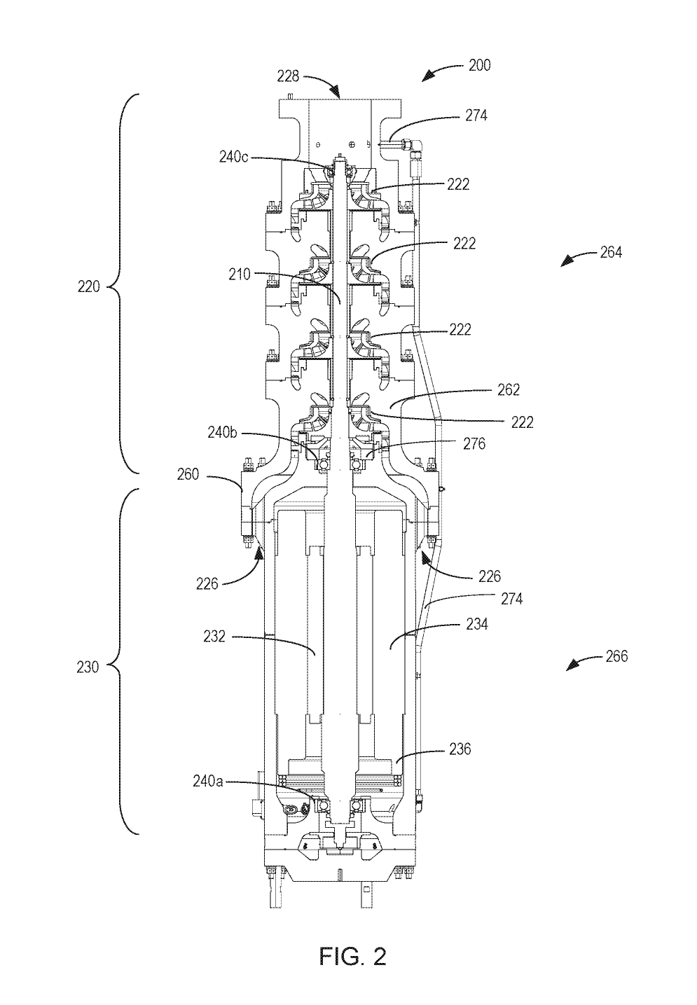

FIG. 2 is a cross-sectional view of a turbine and electric generator assembly 200, according to some non-limiting embodiments or aspects of the present disclosure. The turbine and electric generator assembly 200 is configured to be submerged in a liquified gas. The liquified gas can have a very low temperature. The cryogenic liquid can be liquid ammonia. Ammonia has a boiling point of approximately –33.34 ºC or –28.01 °F at atmospheric pressure. As identified above, liquid ammonia as a liquified gas can be stored at atmospheric pressure and a temperature of approximately –33 ºC or less.

With reference to FIG. 2, the turbine and electric generator assembly 200 includes a shaft 210 configured to rotate around an axis. The axis (not shown) can be a central axis of the shaft 210. The shaft 210 can be a single shaft. That is, the turbine and electric generator assembly 200 can have only one shaft 210. Furthermore, the shaft 210 can have a composition that is made of only one material. Therefore, the shaft 210 can be a single, monolithic shaft. The shaft 210 can be made of stainless steel, such as austenitic, ferritic, or martensitic stainless steel. In a preferred embodiment, the shaft 210 is made of 15-5 PH stainless steel. As will be discussed below, the runner 222 of the turbine 220 and the rotor 232 of the generator 230 can each be fixed to this single shaft 210. Therefore, the shaft 210 can also be a common shaft shared by each of the runner 222 of the turbine 220 and the rotor 232 of the generator 230. The runner 222 of the turbine 220 and the rotor 232 of the generator 230 can each be fixed to the shaft 210 by any mechanism known in the art. Fixing the runner 222 of the turbine 220 and the rotor 232 of the generator 230 to a single, common shaft simplifies the design, increases the stiffness of the assembly, and eliminates a shaft coupling and a nitrogen-purged space from the assembly.

The turbine and electric generator assembly 200 includes a turbine 220. The turbine 220 includes at least one runner 222 and a liquid flow path 224, including an inlet 226 and an outlet 228. In one embodiment, as shown in FIG. 2, the turbine 220 includes multiple runners 222. However, in another embodiment, the turbine 220 can include only one runner 222. The at least one runner 222 is fixed to the shaft 210 and is configured to rotate around the axis together with the shaft 210. Each runner 222 can include a body having a hub, vanes or blades, a wear ring that separates the high-pressure fluid from the low-pressure fluid in each stage, and at least one key that allows the runner to transmit torque to the shaft 210. Each runner 222 can be fixed to the shaft 210 at the hub. The vanes or blades can receive a pressurized flow of the liquid, and the force of the liquid on the vanes or blades causes each runner 222 to rotate. The runner 222 can be made of aluminum or stainless steel. In a preferred embodiment, the runner 222 is made of aluminum. Operation of the turbine 220 will be discussed below.

The turbine and electric generator assembly 200 includes a generator 230. The generator 230 includes a rotor 232 fixed to the shaft 210 and a stator 234 surrounding the rotor 232. The rotor 232 is configured to rotate around the axis together with the shaft 210. The generator 230 can have a rated power range of approximately 167 kW to approximately 2,674 kW. The rated power is the upper limit of power output that the generator 230 can continuously maintain without damage or failure to the generator 230. The generator 230 can have a rated torque range of approximately 443 N-m to approximately 8,511 N-m. The rated torque is the upper limit of torque that the generator 230 can continuously produce or withstand at its rated power. The generator 230 can have a rated synchronous speed of 3,000 RPM or 3,600 RPM. A broader speed range can be achieved through the use of a VFD.

FIG. 3 is an expanded, partial, and cutaway view of a conductive winding 236, according to some non-limiting embodiments or aspects of the present disclosure. The stator 234 can include a stator core having slots and conductive windings 236 positioned in the slots such that the conductive windings 236 circumferentially surround the rotor 232. With reference to FIG. 3, the conductive windings 236 include a conductor 238. The conductor 238 includes aluminum. In one embodiment, the conductor 238 includes an aluminum content of at least 95% by weight. In another embodiment, the conductor 238 consists entirely of aluminum. In one embodiment, the conductor 238 is an aluminum alloy.

The conductive windings 236 can include a coating 250 surrounding the conductor 238. With reference to FIG. 3, at least a portion of the coating 250 is cut away to reveal the conductor 238. In one embodiment, the coating 250 can surround the entire outer surface of the conductor 238. However, in another embodiment, the coating 250 partially surrounds the outer surface of the conductor 238. The coating 250 can be made of an aromatic polyamide (aramid) or a polyaryletherketone (PAEK). In a preferred embodiment, the coating 250 is made of aramid paper or fibers. In another preferred embodiment, the coating 250 is made of polyether ether ketone (PEEK). As will be discussed below, the conductive windings 236 are submerged in the liquid flow path 224 of the liquified gas thereby cooling the conductive windings 236 during operation.

Each of the conductive windings 236 can have a voltage rating of approximately 4,160 V. With developments, it is anticipated that each of the conductive windings 236 can have a voltage rating of approximately 6,600 V. Aluminum is approximately 1.6 times as resistive as copper. Therefore, conductive windings 236 having both an aluminum composition and a voltage rating of approximately 6,600 V are not readily available. The voltage rating is the upper limit of voltage that the conductive windings 236 can continuously handle without damage, failure, and/or dielectric breakdown to the conductive windings 236.

The rotor 232 can include a stack of silicon iron laminations held together by aluminum rotor bars and aluminum end caps.

The turbine and electric generator assembly 200 can include a housing 260 and an interior 262. Each of the turbine 220 and the generator 230 can be positioned inside the housing 260 within the interior 262. That is, because the turbine and electric generator assembly 200 can have only one shaft 210 and because the runner 222 of the turbine 220 and the rotor 232 of the generator 230 can each be fixed to this single shaft 210, two separate housings for each of the turbine 220 and the generator 230 are not required. Therefore, the turbine and electric generator assembly 200 can have only one housing 260, in which the interior 262 is defined by the housing 260 within both the turbine 220 and the generator 230. Nonetheless, while the turbine and electric generator assembly 200 does not include a turbine housing and a separate generator housing, for the understanding of the present disclosure, the housing 260 can be considered to include a turbine side 264 and a generator side 266.

Each of the rotor 232 and the stator 234 can be positioned inside the housing 260 within the interior 262 at the generator side 266. At the generator side 266, the housing 260 can include an interior sidewall circumferentially or annularly surrounding the generator 230. The stator 234 can be fixed to at least a portion of the interior sidewall of the housing and can annularly or circumferentially surround the rotor 232.

While the turbine and electric generator assembly 200 can have only one housing 260, the housing 260 may be formed by a plurality of housing components. The housing 260 can be made of aluminum or stainless steel. In a preferred embodiment, the housing 260 is made of aluminum.

The turbine and electric generator assembly 200 can include bearings 240a-c surrounding the shaft 210. For example, the generator side 266 can include bearings 240a, 240b surrounding the shaft 210 and the turbine side 264 can include bearing 240c surrounding the shaft 210. The bearings support the rotation of the shaft 210 and reduce friction thereof during operation of turbine and electric generator assembly 200. As shown in FIG. 2, the generator 230 can include multiple bearings 240a-c each positioned in proximity to different portions of the shaft 210. For example, an upper bearing 240c can be positioned in proximity to an upper portion the shaft 210, a central bearing 240b can be positioned in proximity to a central portion of the shaft 210, and/or a lower bearing 240a can be positioned in proximity to a lower portion of the shaft 210. As will be discussed below, the bearings 240a-c are submerged in the liquid flow path 224 of the liquified gas thereby cooling and lubricating the bearings 240a-c during operation of the turbine and electric generator assembly 200. The bearings 240a-c can be made of steel or stainless steel with silicon nitride balls, such as 440C stainless steel or SAE 52100 steel with silicon nitride balls. In a preferred embodiment, the bearings 240a-c are made of SAE 52100 steel with silicon nitride balls.

Operation of the turbine and electric generator assembly 200 is as follows. The conductive windings 236 of the stator 234 receive an alternating current from a power supply (not shown). The alternating current is a “no-load current” flowing through the conductive windings 236 of the stator 234 that induces a rotating magnetic field that rotates at the frequency of the power supply. A flow control valve of the turbine 220 is opened such that the liquid inlet 226 of the turbine 220 receives a pressurized flow of the liquified gas. The pressurized flow of the liquified gas flows into each runner 222, causing each runner 222 to rotate. The rotation of each runner 222 thereby causes the shaft 210 and the rotor 232 to rotate. The rotation of the rotor 232 induces a rotating magnetic field in the rotor 232. If the rotor 232 is allowed to rotate at a speed in which the rotating magnetic field of the rotor 232 is faster than the rotating magnetic field of the stator 234, “negative slip” is produced between the magnetic field of the rotor 232 and the magnetic field of the stator 234. The “negative slip” produces an electric current through the conductive windings 236. That is, the turbine and electric generator assembly 200 ultimately converts mechanical torque that drives the rotor 232 of the turbine 220 into electrical current flowing from the conductive windings 236 of the stator 234 of the generator 230.

More specifically, when the liquid inlet 226 and each runner 222 receive a pressurized flow of the liquified gas, each runner 222, the shaft 210, and the rotor 232 rotate. The liquified gas is depressurized as each runner 222 rotates, and the liquified gas flows through at least a portion of the liquid flow path 224 and the outlet 228. Because the turbine and electric generator assembly 200 does not require a magnetic coupling nor a pressure barrier between the turbine 220 and the generator 230, the turbine and electric generator assembly 200 can withstand a greater torque to each runner 222, the shaft 210, and the rotor 232 than conventional cryogenic turbines/generators that rely on magnetic couplings for transmission of torque. The greater torque tolerance by the turbine and electric generator assembly 200 allows the electric motor and pump assembly 100 to tolerate greater head than turbines/generators that rely on magnetic couplings for transmission of torque. The turbine and electric generator assembly 200 can withstand a head of at least approximately 400 meters and at most approximately 1600 meters. The turbine and generator assembly 200 can have a flow rate of the liquid at the liquid inlet 226 of at least approximately 250 m³/hour and at most approximately 1,000 m³/hour. The turbine is configured to receive the liquid at the liquid inlet at a pressure of at least 200 bar. The turbine and electric generator assembly 200 can have an efficiency of 90%.

A portion of the liquid flow path 224 includes the cavities, gaps, or hollow spaces within the generator 230. That is, the liquified gas flows through the hollow spaces surrounding the rotor 232, stator 234, conductive windings 236, and bearings 240a-c. Therefore, the conductive windings 236 are submerged in the liquid flow path 224 of the liquified gas thereby cooling the conductive windings 236 during operation of the turbine and electric generator assembly 200. That is, heat or energy that is generated in the conductive windings 236 during operation of the turbine and electric generator assembly 200 is transferred to the liquified gas. Furthermore, the bearings 240a-c are submerged in the liquid flow path 224 of the liquified gas thereby cooling and lubricating the bearings 240a-c during operation of the turbine and electric generator assembly 200. That is, heat or energy that is generated in the bearings 240a-c during operation of the turbine and electric generator assembly 200 is transferred to the liquified gas, and friction that is generated by the movement of the components of the bearings 240a-c is minimized by contact with the liquified gas.

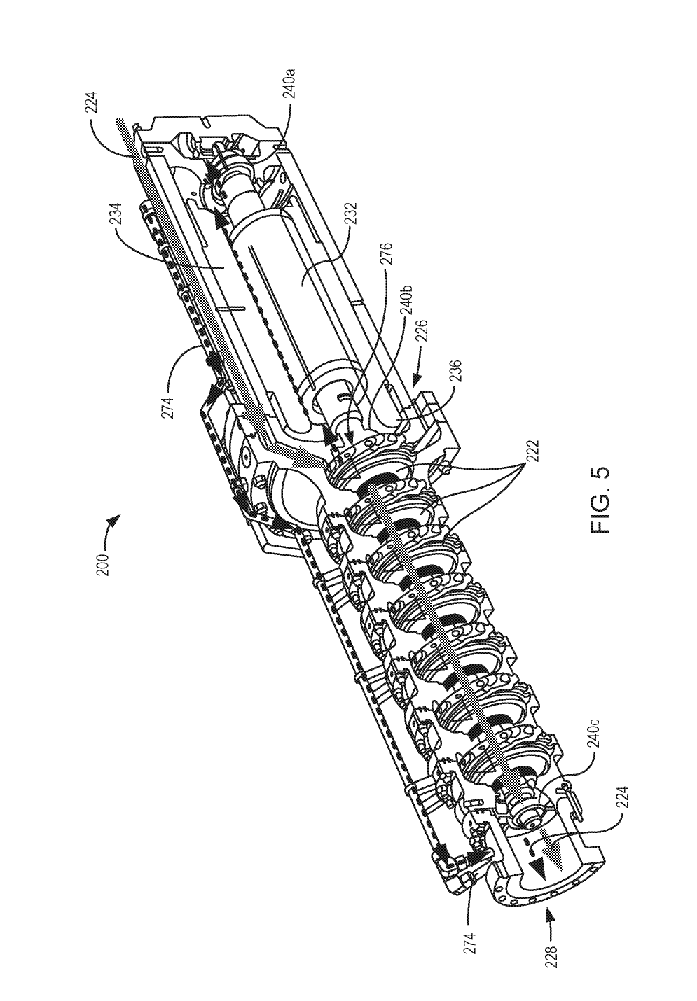

With reference to FIG. 5, flow of the liquified gas through the liquid flow path 224 in the turbine and electric generator assembly 200 is as follows. As shown by the solid gray arrows in FIG. 5, the liquified gas enters inlet 226 at high pressure. The high pressure liquified gas enters nozzle vanes (not shown) at each runner 222 where the liquified gas is accelerated prior to entering each runner 222 to convert static pressure of the liquified gas into dynamic pressure. The dynamic pressure is recovered from the liquefied gas and is converted into shaft torque by each runner 222. At least a portion of the liquified gas passes through the upper bearing 240c, which cools and lubricates the upper bearing 240c, and exits the outlet 228 at discharge (lower) pressure.

As shown by the black arrows composed of dashes, a portion of the liquified gas flowing through the initial runner 222 is diverted through a thrust equalizing mechanism (TEM®) 276 and the central bearing 240b, which cools and lubricates the central bearing 240b. This portion of the liquified gas passes through the gap between the rotor 232 and the stator 234, which cools the conductive windings 236. Furthermore, this portion of the liquified gas passes through the lower bearing 240a, which cools and lubricates the lower bearing 240a, and exits to the outlet 228 side of the turbine 220 through the return line 274. The thrust equalizing mechanism 276 is described in U.S. Patent No. 9,341,191 B2, the disclosure of which is incorporated herein by reference in its entirety. The thrust equalizing mechanism 276 removes thrust loads on the bearings 240 in the turbine and electric generator assembly 200 and allows for cooling of the conductive windings 236 and cooling and lubrication of the central bearing 240b.

While various aspects of the disclosed electric motor and pump assembly 100 and the disclosed turbine and electric generator assembly 200 were provided in the foregoing description, those skilled in the art may make modifications and alterations to these aspects without departing from the scope and spirit of this disclosure. For example, it is to be understood that this disclosure contemplates that, to the extent possible, one or more features of any aspect can be combined with one or more features of any other aspect. Accordingly, the foregoing description is intended to be illustrative rather than restrictive. Therefore, the above-described exemplary aspects should not be considered to limit the scope of the appended claims.

What is claimed is:

1. An electric motor and pump assembly configured to be submerged in liquid ammonia, the motor and pump assembly comprising:
a shaft configured to rotate around an axis;
a pump comprising at least one impeller and a liquid flow path comprising an inlet and an outlet, wherein the at least one impeller is fixed to the shaft and is configured to rotate around the axis together with the shaft; and
a motor comprising:
a rotor fixed to the shaft, wherein the rotor is configured to rotate around the axis together with the shaft; and
a stator surrounding the rotor, the stator comprising conductive windings,
wherein the conductive windings are configured to receive an electric current thereby causing the rotor, the shaft, and the at least one impeller to rotate and produce a pressurized flow of the liquid ammonia through at least a portion of the liquid flow path and the liquid outlet, and
wherein the conductive windings comprise a conductor, the conductor comprising aluminum.

2. The motor and pump assembly of claim 1, wherein the shaft comprises a single shaft.

3. The motor and pump assembly of claim 1, wherein the conductive windings are submerged in the liquid flow path of the liquid ammonia thereby cooling the conductive windings during operation.

4. The motor and pump assembly of claim 1, further comprising:
bearings surrounding the shaft, wherein the bearings are submerged in the liquid flow path of the liquid ammonia thereby cooling and lubricating the bearings during operation.

5. The motor and pump assembly of claim 1, wherein the conductive windings further comprise a coating surrounding the conductor.

6. The motor and pump assembly of claim 1, wherein the conductor comprises an aluminum content of at least 95% by weight.

7. The motor and pump assembly of claim 1, wherein the conductor consists entirely of aluminum.

8. The motor and pump assembly of claim 1, wherein the pump is configured to discharge the liquid ammonia from the liquid outlet at a flow rate of at least approximately 900 m³/hour and at most approximately 2,500 m³/hour.

9. The motor and pump assembly of claim 1, wherein the motor has a rated power range of approximately 188 kW to approximately 1,160 kW.

10. The motor and pump assembly of claim 1, wherein each of the conductive windings have a voltage rating of approximately 4,160 V.

11. The motor and pump assembly of claim 1, wherein the motor has a rated torque range of approximately 997 N-m to approximately 7,388 N-m.

12. A turbine and electric generator assembly configured to be submerged in liquid ammonia, the turbine and generator assembly comprising:
a shaft configured to rotate around an axis;
a turbine comprising at least one turbine runner and a liquid flow path comprising an inlet and an outlet, wherein the at least one turbine runner is fixed to the shaft and is configured to rotate around the axis together with the shaft; and
a generator comprising:
a rotor fixed to the shaft, wherein the rotor is configured to rotate around the axis together with the shaft; and
a stator surrounding the rotor, the stator comprising conductive windings,
wherein the liquid inlet of the turbine is configured to receive a pressurized flow of the liquid ammonia thereby causing the at least one runner, the shaft, and the rotor to rotate and produce an electric current through the conductive windings,
wherein the conductive windings comprise a conductor, the conductor comprising aluminum.

13. The turbine and generator assembly of claim 12, wherein the shaft comprises a single shaft.

14. The turbine and generator assembly of claim 12, wherein the conductive windings are submerged in the liquid flow path of the liquid ammonia thereby cooling the conductive windings during operation.

15. The turbine and generator assembly of claim 12, further comprising:
bearings surrounding the shaft, wherein the bearings are submerged in the liquid flow path of the liquid ammonia thereby cooling and lubricating the bearings during operation.

16. The turbine and generator assembly of claim 12, wherein the conductive windings comprise a coating surrounding the conductor.

17. The turbine and generator assembly of claim 12, wherein the conductor comprises an aluminum content of at least 95% by weight.

18. The turbine and generator assembly of claim 12, wherein the conductor consists entirely of aluminum.

19. The turbine and generator assembly of claim 12, wherein the turbine is configured to withstand a head of the liquid ammonia of at least approximately 400 meters and at most approximately 1600 meters.

20. The turbine and generator assembly of claim 12, wherein the generator has a rated power range of approximately 167 kW to approximately 2,674 kW.

21. The turbine and generator assembly of claim 12, wherein each of the conductive windings have a voltage rating of approximately 4,160 V.

22. The turbine and generator assembly of claim 12, wherein the generator has a rated torque range of approximately 443 N-m to approximately 8,511 N-m.
